(19) United States
(12) Patent Application Publication
(10) Pub. No.: US 2006/0009143 A1
(43) Pub. Date: Jan. 12, 2006

(54) Field dressing tool

(76) Inventor: William Gayle Rodgers, Madras, OR (US)

Correspondence Address: Carl D. Crowell, P.O. Box 923, Salem, OR, 97308, US

(21) Appl. No.: 10/876,798

(22) Filed: Jun. 24, 2004

(51) Int. Cl. A22B 5/10

(52) U.S. Cl. 452/102

(57) ABSTRACT

A method for use of a field dressing tool for eviscerating an animal in the field without breaking the pelvic bone of the animal providing has a handle portion having a first end and an opposing second end, a grasping loop having a first loop end and a second loop end. The first loop end is fixedly attached to the second end of the handle. The second loop end is a joining loop encircling the first loop end of the grasping loop, wherein the grasping loop is slipped under the pelvis of the animal and closed firmly around the anal vent and urinary tract of the animal. The field dressing tool is pulled in tandem with the entrails of the animal thereby eviscerating the animal.

### FIELD OF THE INVENTION

The present invention relates to field dressing tools and more particularly to a field dressing tool used to eviscerate animals.

### BACKGROUND OF THE INVENTION

Field dressing is the procedure performed by hunters proximate the time of killing a game animal to prevent the contamination and spoiling of the game meat. Typically, field dressing is performed to immediately remove the entrails and the feed from the animal before transporting the meat to a site for final cleaning, refrigeration or cooking.

Evisceration is the removal of the viscera, or entrails of an animal. Eviscerating a large animal in the field, for example a deer is considered by most to be an unpleasant and messy chore typically performed with a large knife. The inevitable result of this process being that the person doing the eviscerating becomes well spattered with blood, entrails, and shards of bone. The hands and arms are particularly vulnerable since they must be inserted into the carcass to remove the entrails. In addition, in utilizing only a knife, it is difficult to cleanly and completely remove all of the entrails since to accomplish this feat the pelvic bone must be split—a difficult task with only a knife. Generally the knife is used to chop at the bone, or if available a small hatchet is used for this purpose.

Even more unfortunate than the heavy work and mess associated with this procedure, is the possibility of puncturing or tearing the entrails and releasing their contents into the carcass, thereby contaminating the game meat. The pelvis of a deer is small and difficult to accomplish the task of removing the anal vent and urinary tract without splitting the pelvic bone. Puncturing the urine bladder can taint the flesh resulting in meat that does not have optimum taste. Typically the anal vent and the urinary tract are tied off prior to removing them from the carcass in an effort to minimize the discharge from either.

The tool of the present invention overcomes these difficulties. It is an object of the present invention to provide a means of eviscerating an animal in the field without breaking the pelvis bone thereby cutting near the urine bladder. It is a further objective of the present invention to provide a field dressing tool that ties off the anal vent and the urinary tract of the animal while removing the entrails thereby minimizing the potential of contaminating the carcass with the contents of either.

The present invention provides means by which the steps involved in eviscerating an animal can be carried out neatly and conveniently in the field and with a minimum probability of carcass contamination.

### SUMMARY OF THE INVENTION

The present invention is a field dressing tool for eviscerating an animal in the field without breaking the pelvic bone of the animal. The field dressing tool has a handle with a first end and an opposing second end. There is a grasping loop that has a first loop end and a second loop end. The first loop end is fixedly attached to the second end of the handle. The second loop end is a joining loop. The joining loop encircles the first loop end of the grasping loop creating a closed loop or a noose. The grasping loop is slipped under the pelvic bone of the animal and closed firmly around the anal vent and urinary tract of the animal and pulled tight to seal off the anal vent and urinary tract. The handle is then pulled in tandem with the entrails of the animal thereby eviscerating the animal quickly while minimizing the potential of contaminating the animal carcass. A loop keeper portion is slidably affixed to the first loop end so that when the joining loop is firmly slipped down the grasping loop the loop keeper is slid against the joining loop thereby locking the joining loop in place.

### BRIEF DESCRIPTION OF THE DRAWINGS

The above description and other objects, advantages, and features of the present invention will be more fully understood and appreciated by reference to the specification and accompanying drawing, wherein:

FIG. 1 is a perspective view of the field dressing tool of the present invention.

### DETAILED DISCUSSION OF THE PREFERRED EMBODIMENTS

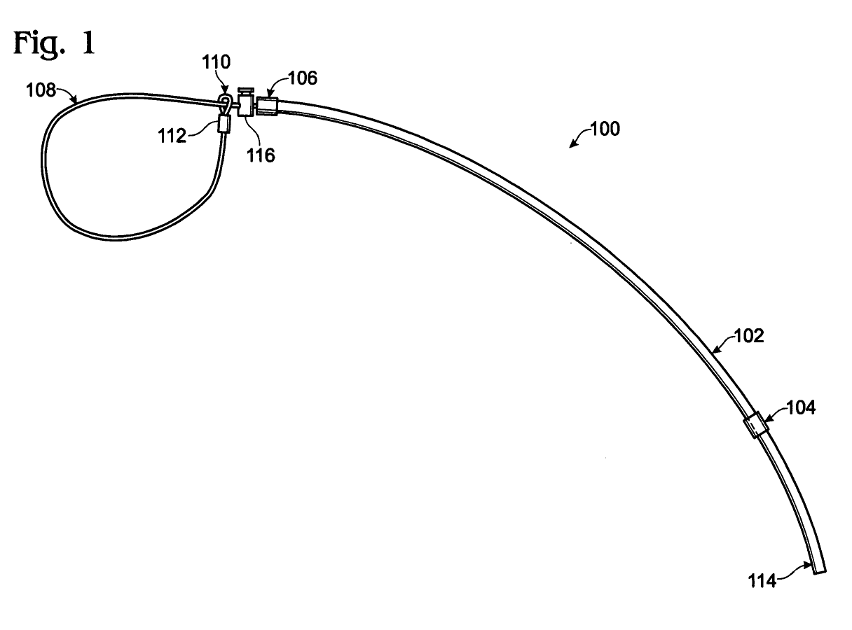

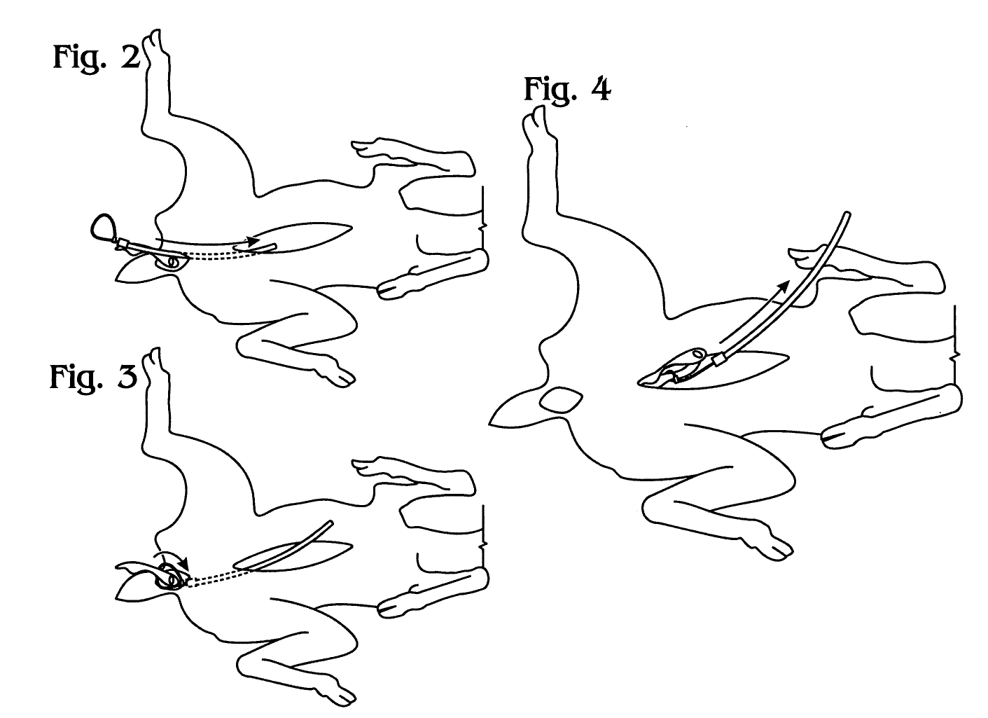

FIG. 1 is a perspective view of Field Dressing Tool 100. Handle 102 is a flexible, plastic-coated, metal cable in the preferred embodiment. Handle 102 can be any rigid or semi-rigid rod able to be pushed through the pelvis by Handle 102. Handle 102 extends from Handle End 114 to Handle/Loop Crimp 106. The length of Handle 102 is adequate to extend from the top of the animal's pelvis bone to the bottom of the pelvis bone. Additional length on Handle 102 is necessary to allow for grasping by the eviscerator.

Grip Portion 104 is located approximately four inches below Handle End 114. In the preferred embodiment, Grip Portion 104 is a hollow metal piece, sometimes referred to as a “cable stop,” crimped around Handle 102.

Grasping Loop 108 is a thin section of cable of adequate length to encircle the anal vent and urinary tract. Grasping Loop 108 can be of any flexible, thin, cord-like material that has adequate strength. In the preferred embodiment, the Grasping Loop 108 is capable of holding ten to thirty pounds under pressure without breaking. Grasping Loop 108 is attached to Handle 102 by Handle/Loop Crimp 106 which is also a cable stop that firmly attaches Handle 102 and Grasping Loop 108. Grasping Loop 108 ends with Joining Loop 110 that encircles Grasping Loop 108 creating a noose from Grasping Loop 108. Joining Loop 110 is secured as a loop of Grasping Loop 108 by another crimping piece—End Loop Crimp 112.

In operation, the game animal, generally a deer or elk is cut with a knife around the anus. The stomach is also cut open exposing the animal's entrails. Without breaking the pelvis, Field Dressing Tool 100 is slid Grasping Loop 108 first under the pelvic bone. In the preferred mode of operation, the Field Dressing Tool 100 is inserted from the anal vent area toward the stomach area. Grasping Loop 108 is slipped around the anal vent and the urinary tract of the animal then pulled tight to seal them both off. Loop Keeper 116 is slid firmly against Joining Loop 110 to keep Grasping Loop 108 from opening. Next, the animal is eviscerated. With a firm grasp at Grip Portion 104, while pulling the stomach and other entrails from the animal, Field Dressing Tool 100 is pulled in tandem removing all of the entrails with the urine bladder and bowels sealed off by Grasping Loop 108 thereby avoiding any contamination of the carcass.

Wherein the terms and expressions which have been employed in the foregoing specification are used therein as terms of description and not of limitation, there is no intention, in the use of such terms and expressions, of excluding equivalents of the features shown and described or portions thereof, it being recognized that the scope of the invention is defined and limited only by the claims which follow.

1. A field dressing tool for eviscerating an animal in the field without breaking the pelvic bone of the animal, comprising:
a handle portion having a first end and an opposing second end, and;
a grasping loop having a first loop end and a second loop end, said first loop end fixedly attached to said second end of said handle, said second loop end being a joining loop encircling said first loop end of said grasping loop giving said grasping loop a noose shape.

2. The field dressing tool of claim 1, further comprising a loop keeper portion slidably affixed to said first loop end whereby when said joining loop is firmly slipped down said grasping loop said loop keeper is slid against said joining loop thereby locking said joining loop in place.

3. The field dressing tool of claim 1, further comprising a grip portion fixedly attached to said handle in an area approximate said first end wherein while pulling the field dressing tool out of the animal carcass said grip portion would minimize a hand slipping from said handle.

4. A method of eviscerating an animal comprising the steps of:
a. opening the stomach area of an animal and cutting around the anal vent;
b. inserting a field dressing tool with a grip portion and a grasping loop under the pelvis of said animal;
c. securing said anal vent with said grasping loop;
d. eviscerating said animal by pulling on said grip portion.
